(19) United States
(12) Patent Application Publication
(10) Pub. No.: US 2014/0090850 A1
(43) Pub. Date: Apr. 3, 2014

(54) SHALE OIL AND GAS FRACTURING FLUIDS CONTAINING ADDITIVES OF LOW ENVIRONMENTAL IMPACT

(71) Applicant: Battelion Energy LLC, Columbia, SC (US)

(72) Inventors: Brian C. BENICEWICZ, Columbia, SC (US); Gordon W. Calundann, North Plainfield, NJ (US)

(73) Assignee: Battelion Energy LLC, Columbia, SC (US)

(21) Appl. No.: 14/043,008

(22) Filed: Oct. 1, 2013

Related U.S. Application Data
(60) Provisional application No. 61/744,746, filed on Oct. 3, 2012.

(51) Int. Cl. C09K 8/68; E21B 43/26

(52) U.S. Cl. CPC C09K 8/68; E21B 43/26
USPC 166/308.2; 507/221; 507/225; 507/224

(57) ABSTRACT

The present invention relates to improved chemical additives for use in hydraulic fracturing fluids for the recovery of oil or natural gas entrained in deep-layer shale formations. Many chemical agents currently in use in such water/sand (or other proppants) mixtures could pose human and animal health risks if these chemicals migrate from the shale beds into the environment contaminating the water table, rivers, streams and lakes. The fracturing fluid chemical additives of this invention are designed to be retained or anchored in or near the deep shale layers and are prevented, or greatly delayed from upward migration. Specifically, many chemical additives required for proper fracturing fluid performance can be chemically bonded to inert particulate materials before incorporation into said fluids. The fracturing fluid chemical additives are able to perform their function in the shale fracturing process, and then become nearly permanently trapped in the shale layers protecting the environment above.

### FIELD OF THE INVENTION

The invention relates to chemical additives for use in hydraulic fracturing fluids used in oil and natural gas recovery from shale formations.

### BACKGROUND OF THE INVENTION

The intensifying societal quest for more energy, and in particular hydrocarbon based energy, has driven exploration further afield, from deep sea drilling for oil to the search for oil and gas ever deeper in the earth's crust. In recent years, gas entrained in deep shale formations has come very much into focus. The improved technology of gas extraction combined with an increased understanding of the vast extent of gas bearing shale underlying many of the world's continents has given rise to a development rate and scale of almost land rush proportion. Early development is currently most pronounced in the United States. In that regard, North America is blessed with enormous shale deposits that hold the promise of abundant, relatively low cost natural gas supply for a century or longer. There are, however, several difficulties in recovering this gas. The gas is held tightly in the shale deposits at depths of 2 thousand feet and more. Thus, recovery must involve breaking up or hydraulically fracturing the shale to induce release of the gas. Typically, water containing suspended sand, ceramics, clays or other particulates are pumped at high pressure into the shale through vertical and horizontal bore-holes. The particulate material in the fracturing mixture is entrained in the fractured shale and serves to hold open fracture sites facilitating gas release.

Fracturing fluids also contains a variety of chemicals, often from 3 to more than a dozen, in total up to about 2 percent of the mixture. These chemicals impart certain properties to the fluid, properties critical for oil and gas recovery and optimum well operation. Biocides, clay stabilizers, corrosion inhibitors, crosslinkers, fluid friction reducers, gelling agents, scale inhibitors, surfactants, pH control agents and other materials are among the necessary chemical additives used in fracturing fluids. The chemicals selected for a given fracture fluid are site specific for the type of shale to be fractured. Variations in shale thickness, presence of natural fractures, borehole geometry and site drilling density all play a role in additive choice. Since each gas well requires millions of gallons of fracturing fluid, significant quantities of these water-soluble chemical additives are injected into the shale layers. This leads directly to another major shale fracturing concern: potential chemical contamination of ground water thousands of feet above the shale layers.

For example, the drilling and hydraulic fracturing of a typical gas well in the Marcellus Shale formation underlying most of western, central and northern Pennsylvania requires nearly 4 million gallons of fracturing fluid. While the exact composition of a fracturing fluid will vary depending on geological conditions of the individual well, it is reasonable to assume that 0.5-2% of the primarily water/sand fracturing suspension is composed of chemical additives. Approximately 60% of the fluid pumped into the well returns up the wellbore once applied pressure is released and this recovery liquid can be reused. This calculates to 14-32 thousand gallons of chemical additives injected into the fractured shale for each and every well drilled, and this is the fraction that would remain in the shale and surrounding strata. The danger of widespread ground water contamination over time caused by slow upward migration of some of these chemicals has the potential to become a genuine environmental catastrophe. Chemical additive leakage from well flowback holding basins is another possible source of ground water contamination. As federal, state and local authorities are now engaged in collecting and analyzing ground water near drilling sites and further afield, evidence is beginning to accumulate suggesting the environmental concerns are real. Low levels of some of these chemical additives have been detected in rivers and streams in those areas of intense drilling activity, although the origin of most of these chemicals remains in controversy. Monitoring studies continue and both the energy companies, the EPA and state environmental authorities remain at work to find ways to recover the needed oil or gas at much lower risk.

An examination of the chemical additive package indicates that just three components make up about 60% of the total. Hydrochloric acid is typically the largest fraction of the additive mix at about 25%, and it is generally believed that most or all of this dilute acid is neutralized by carbonate rock almost always present to some degree in underlying strata. Thus, no hydrochloric acid is expected to reach ground water and so far there is little evidence that this has occurred. The acid serves to solubilize certain minerals to foster crack initiation in the shale layer, and to some extent clear damage caused by drilling mud in the vicinity of the wellbore. Another important fraction of the additive package is a friction reducer at about 18-20% of the total; these materials are often referred to ‘slickwater’. The friction reducers allow fracturing fluids and proppant (sand) to be pumped to the target zone at higher rates and reduced pressures than if they were not used. Fluid friction reduction is critical to the effective fracturing process. Generally the friction reducer in common use is polyacrylamide. This water-soluble polymer does not easily degrade in the environment and is considered a toxic contaminant when found in ground water. A surfactant, often lauryl sulfate, is the third most predominant component of the additive mix at about 16-17%. Lauryl sulfate serves the dual function of increasing the viscosity of the fracture fluid while preventing emulsion formation. Again, it would be an environmental hazard should this material reach the water table in high concentration.

Present in lower concentration (˜9-10%) in fracture fluids, and similar to polyacryamide, are copolymers of acrylamide and sodium acrylate used as scale inhibitors. Sodium polyvinylcarboxylate is also used for this function. And again, these materials do not easily degrade and represent biohazards when found in the water table.

In summary, shale gas and oil recovery is vital to any nation's welfare and that is particularly true for the United States, but recovery must be accomplished in an optimized fracturing process at the lowest possible cost to the environment.

| Compound* | Purpose | Common application |
|---|---|---|
| Acids | Helps dissolve minerals | Swimming pool cleaner |
| | and initiate fissure in rock | |
| | (pre-fracture) | |
| Glutaraldehyde | Eliminates bacteria in the | Disinfectant; Sterilizer for |
| | water | medical and dental |
| | | equipment |
| Sodium Chloride | Allows a delayed break | Table salt |
| | down of the gel polymer | |
| | chains | |
| N,N-Dimethylformamide | Prevents the corrosion of | Used in pharmaceuticals, |
| | the pipe | acrylic fibers and plastics |
| Borate salts | Maintains fluid viscosity | Used in laundry |
| | as temperature increases | detergents, hand soaps |
| | | and cosmetics |
| Polyacrylamide | Minimizes friction | Water treatment, soil |
| | between fluid and pipe | conditioner |
| Petroleum distillates | “Slicks” the water to | Make-up remover, |
| | minimize friction | laxatives, and candy |
| Guar gum | Thickens the water to | Thickener used in |
| | suspend the sand | cosmetics, baked goods, |
| | | ice cream, toothpaste, |
| | | sauces, and salad |
| | | dressing |
| Citric Acid | Prevents precipitation of | Food additive; food and |
| | metal oxides | beverages; lemon juice |
| Potassium chloride | Creates a brine carrier | Low sodium table salt |
| | fluid | substitute |
| Ammonium bisulfite | Removes oxygen from | Cosmetics, food and |
| | the water to protect the | beverage processing, |
| | pipe from corrosion | water treatment |
| Sodium or potassium | Maintains the | Washing soda, |
| carbonate | effectiveness of | detergents, soap, water |
| | other components, such | softener, glass and |
| | as crosslinkers | ceramics |
| Proppant | Allows the fissures to | Drinking water filtration, |
| | remain open so the gas | play sand |
| | can escape | |
| Ethylene glycol | Prevents scale deposits | Automotive antifreeze, |
| | in the pipe | household cleansers, |
| | | deicing, and caulk |
| Isopropanol | Used to increase the | Glass cleaner, |
| | viscosity of the fracture | antiperspirant, and hair |
| | fluid | color |

### SUMMARY OF THE INVENTION

It is therefore the primary object of the invention to render the most dangerous of the chemical additives used in fracturing fluids less harmful to the environment. Another objective of this invention is to transform the fracturing process of gas and oil bearing shale formations into one that uses lower quantities of certain chemical additives, particularly those that might be considered “loose” or migratory in such shale formations.

Yet another objective of the invention is to allow a more efficient use of these chemicals in the process during subsequent fracturing fluid injections of the same wellbore. These objectives are all accomplished selecting a proppant or other particulate and by binding these additives to these particulate materials in such a manner so that the additives can perform their function as a component in the fracturing fluid during the shale fracturing process, yet present minimal contamination to ground water in contact with human communities and the surface environment. Further, as these bound additives become entrained in the shale strata, the additives are then able to continue to perform their functions during later fluid injections. It is expected that upward chemical additive migration to the water table or surface water bodies would be eliminated or significantly retarded using the technology of this invention. It is further anticipated that these additive bound particulates will perform the function of shale release far more efficiently. Particulate-bound chemical additives of course may be easily filtered should these be found in flowback holding basins thus ensuring no leakage into the environment.

Attaching the water-soluble chemical additives, such polyacrylamide, to water insoluble particulate materials ensures that additives are entrained or captured in or near the fractured shale strata. This capturing mechanism actually tends to increase the concentration of certain additives in regions where they are required for efficient gas release. The captured chemical additives continues to perform their function in the fracturing process but are prevented from migration and possible contamination of surface water. Many kinds of particulate minerals may be used in this invention but those most preferred include silica, quartz, clays and metal oxides such as alumina and titanium dioxide. Clays generally arise from four major classes: kaolinite, illite, chlorite, and/or montmorillonite-smectite, including but not limited to: ripidolite, rectorite, bentonite, ferriginous-smectite, vermiculite, saponite, sepiolite, cookeite, beidellite, nontronite, barasym, and corrensite. Many polymers and copolymers useful as chemical additives in gas-bearing shale fracturing fluids may also be attached to particulate materials. These would include but not be limited to any polymers derived from vinyl based monomers, for example, acrylic acid and methacrylic acid and, for example, their salts of alkali metals and alkaline earth metals, acrylamide, methacrylamide, mono- and dialkyl(meth)acrylamides. In fact, almost any monomer capable of free radical polymerization is compatible and useful for the technology of this invention.

A broad variety of surfactants may also be attached to particulate materials of this invention. For example, these include but are limited to polymers derived from ethylene oxide, vinyl monomers of organic carboxylic acids, organic sulfonic acids, and their salts of alkali metals and alkaline earth metals. Also, for example, metal organic sulfonates and sarcosinates are particularly useful. The surfactant materials such as the organic sulfonates may be bound to particles themselves or in combination with the water soluble chemical additives such as polyacrylamide or polyacrylic acid.

In many instances, reversible addition fragmentation techniques (RAFT) and atom transfer radical polymerization (ATRP) polymerization procedures have been found to be most effective in preparing the particulate bonded chemical additives of this invention.

Further, by tailoring the structure of polymers and surfactants, many the functions of small molecules used in fracturing fluids may be developed in particulate bonded moieties. Thus, the useful properties of small molecule chemical additives may be captured in particulate bonded additives with desirable very low migration rates or these moieties. Laboratory experimental evidence presented here indicates that in some instances these particulate bonded chemicals may be completely and permanently entrained in the shale strata or adjacent strata.

The following table shows chemical additives used in hydraulic fracturing fluids, particularly some of the types of chemicals currently used in oil and gas shale fracturing fluids and the function each material performs.

| Chemical Name | Chemical Purpose | Product Function |
|---|---|---|
| Hydrochloric acid | Dissolves minerals and initiates cracks | acid |
| | in the rock | |
| Quaternary ammonium | Controls aqueous bacteria that | biocide |
| chloride | produce corrosive by-products | |
| Tetrakis- | Controls aqueous bacteria that | biocide |
| hydroxymethylphosphonium | produce corrosive by-products | |
| sulfate | | |
| Ammonium persulfate | Allows a delayed breakdown of the gel | breaker |
| Calcium chloride | Allows a delayed breakdown of the gel | breaker |
| Choline chloride | Prevents clay from swelling or shifting | clay stabilizer |
| Tetramethyl ammonium | Prevents clay from swelling or shifting | clay stabilizer |
| chloride | | |
| Methanol | Product stabilizer and/or winterizing | corrosion |
| | agent | inhibitor |
| Formic acid, N,N- | Prevents pipe corrosion | corrosion |
| dimethylformamide | | inhibitor |
| Petroleum distillate | Carrier fluid for borate, zirconate | crosslinker |
| | crosslinker, polyacrylamide and Guar | |
| | gum | |
| Borate and/or zirconium | Maintains fluid viscosity as | crosslinker |
| complex | temperature increases | |
| Polyacrylamide | “slicks” the water to minimize friction | friction reducer |
| Polysaccharide blend (e.g., | Thickens water to suspend sand | gelling agent |
| Guar gum) | | |
| Ethylene glycol | Product stabilizer and winterizing | gelling agent |
| | agent | |
| Citric acid, acetic acid, | Prevents precipitation of metal oxides | iron control |
| thioglycolic acid, sodium | | |
| erythrorbate | | |
| Lauryl sulfate, isopropanol, | Prevent emulsion formation in the | non-emulsifier |
| ethylene glycol | fracture fluid | |
| Sodium/potassium | Adjusts the pH of fluid to maintain | pH adjusting |
| hydroxide, | effectiveness of other components | agent |
| sodium/potassium | such as crosslinkers | |
| carbonate | | |
| Copolymer of acrylamide | Prevents scale deposits in pipe | scale inhibitor |
| and sodium acrylate | | |
| Sodium polyacrylate | Prevents scale deposits in pipe | scale inhibitor |
| Phosphoric acid salts | Prevents scale deposits in pipe | scale inhibitor |
| Lauryl sulfate | Used here to increase the viscosity of | surfactant |
| | the fracture fluid | |
| naphthalene | Carrier fluid for surfactants | surfactant |
| | | support |
| Ethanol, methanol, | Product stabilizer and/or winterizing | surfactant |
| isopropanol | gent | support |
| 2-butoxyethanol | Product stabilizer | Surfactant |
| | | support |

### BRIEF DESCRIPTION OF THE DRAWINGS

The accompanying drawings constitute a part of the Specification and serve to assist in further characterizing certain embodiments of the invention.

FIG. 1 is a representative UV analysis calibration curve useful to calculate grafting densities of RAFT agents to silica particles as described hereafter.

FIG. 2 is a representative UV analysis calibration curve useful to determine the concentration of RAFT agents on silica particles as described hereafter.

FIG. 3 is a representative UV analysis absorbance curve useful to determine the graft density on silica particles as described hereafter.

### DETAILED DESCRIPTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

Generally speaking, the present disclosure is directed to the composition, preparation and application of chemical additives for shale gas fracturing fluid market through the versatile and widely applicable methods of attaching chains to particles via grafting-to or grafting-from or grafting through methods. An example of the grafting-from processes is through polymerization from the particle surface (e.g., RAFT polymerization) to synthesize particles with multiple polymeric assemblies. In this technique, consecutive step-by-step polymerizations (e.g., utilizing RAFT polymerization) can be used to prepare particles with multiple polymeric assemblies. In another version of this technique, RAFT polymerization followed by ATRP polymerization can be used to synthesize particles with multiple polymeric assemblies. In the grafting-to technique, polymerization techniques can be used to initially prepare polymers with binding functionalities, and then the preformed polymer can be subsequently attached to the particle surfaces. In the grafting-through technique, polymerization techniques can be used to prepare polymers which react with a reactive functionality on the surface of the particles during the polymerization.

Through these methods, particulate materials can be functionalized with multiple polymeric assemblies. In particular each particle can have one or more different polymeric chains extending therefrom. In certain embodiments, the particles with multiple polymeric assemblies can be formed while maintaining simultaneous control over multiple variables, including but not limited to monomer-type, grafted chain molecular weight, polydispersity, etc. The grafted polymer chains, which are covalently attached to the particle surface, can perform the same function in a fracturing fluid as that polymer not bonded to particulate materials.

In one embodiment, two different types of polymeric assemblies (e.g., a first polymeric chain and a second polymeric chain) can be attached to a particle. In other embodiments, a third type of polymeric assembly (i.e., a third polymeric chain) can also be attached. Additional polymeric assemblies (e.g., a fourth polymeric chain) can also be attached to the surface, depending on the available surface area on the particles and/or the size, dispersity, and/or density of the first, second, and third polymeric chains already present on the surface of the particle.

A preferred embodiment is the attachment of any of the following or combinations of the following to silica particles: polyacrylic acid, polyacrylic acid copolymers, sodium or potassium salts of polyacrylic acid and its copolymers, polyacrylamide and polyacrylamide copolymers. Surfactants such as lauryl sulfate may also be attached to the same particles.

Preparation of Particulate Materials with One or More Polymeric Assemblies

### 1. Particulate Materials:

The presently disclosed methods can be utilized on a variety of different types of particles. The particles may comprise for example natural or synthetic clays (including those made from amorphous or structured clays), inorganic metal oxides (e.g., silica, alumina, and the like), latexes, etc. Particularly suitable particulate materials include inorganic materials such as silica, alumina, titania (TiO₂), indium tin oxide (ITO), CdSe, etc., or mixtures thereof. Organic particulate materials suitable for use include polymeric particles, carbon, graphite, graphene, etc., or mixtures thereof.

Particulates as used herein means particles (including but not limited to rod-shaped particles, spherical-shaped particles, disc-shaped particles, platelet-shaped particles, tetrahedral-shaped particles), fibers, or similarly shaped materials. In one embodiment, the particulates have an average particle size of about 0.01 micron to about 2 millimeters, preferably 10 microns to about 1 mm. That is, the particles have a dimension (e.g., a diameter or length) of about 0.01 micron to 2 mm. A specific particle size distribution (PSD) is selected depending on known morphologies of the underlying shale.

The particles may be crystalline or amorphous. A single type of particulate material may be used, or mixtures of different types of particulates may be used. If a mixture of particles is used they may be homogeneously or non-homogeneously distributed in the fracturing fluid composition. Non-limiting examples of suitable particle size distributions of particles are those within the range of less than about 1 mm, alternatively less than about 0.1 mm, and alternatively less than about 0.01 mm.

It should also be understood that certain particle size distributions may be useful to provide certain benefits, and other ranges of particle size distributions may be useful to provide other benefits (for instance, ‘slickwater’ property enhancement in a given fracturing fluid composition may require a different particle size range than the other properties desired). The average particle size of a batch of particles may differ from the particle size distribution of those particles. For example, a layered synthetic silicate can have an average particle size of about 25 nanometers while its particle size distribution can generally vary between about 10 nm to about 40 nm.

In one embodiment, the particles can be exfoliated from a starting material to form the particles of varying particle size depending on the defoliation process. Such starting material may have an average size of up to about 50 microns. In another embodiment, the particles can be grown to the desired average particle size. Various lots of known average particle size can be blended to prepare particulate with a desired PSD.

### 2. Attaching a First Anchoring Compound to the Particulate Material:

In certain embodiments, a first anchoring compound can be attached to the surface of the particle for subsequent attachment of the first polymeric chains (e.g., via a “grafting-from” or “grafting-to” approach, as described in greater detail below). The first anchoring compound is covalently bonded to the surface of the particle, either directly or via a first functionalization group. The given anchor compound can be selected based upon the type of particle and/or the type of polymeric chain to be attached thereto.

The first anchoring compound has a functional group for further reaction. Suitable functional groups for further reaction can include, but are not limited to, amine groups (e.g., amide groups, azide groups, cyanate groups; nitrate groups, nitrite groups, etc.), thiol groups (e.g., sulfinic acid, sulfonic acid, thiocyanates, etc.), phosphonate groups, hydroxyl groups (e.g., —OH), carboxylic acid groups (e.g., —COOH), aldehyde groups (e.g., —CHO), halogen groups (e.g., haloalkanes, haloformyls, etc.), epoxy groups, alkenes, alkynes, and the like. For example, the anchoring compound can be a RAFT agent, when used with a grafting-from polymerization technique. For example, in one particular embodiment, 4-cyanopentanoic acid dithiobenzoate (CPDB) can be attached to the surface of the particle as a first anchor. In this embodiment, the dithioester anchoring compound can be immobilized onto the surface of the particles (e.g., colloidal silica particles). For instance, the 4-cyanopentanoic acid dithiobenzoate anchoring compound can be attached on the surface of the particles by first functionalizing the surface of the particles with amine groups using 3-aminopropyldimethylethoxysilane. Use of a mono-functional silane such as 3-aminopropyldimethylethoxysilane compared to a trifunctional silane ensures the formation of a monolayer of initiator on the silica surface and prevents particle agglomeration by crosslinking during processing. The ratio of the 3-aminopropyldimethylethoxysilane to silica particles is critical in determining the grafting density. In addition to adjusting the ratio by varying the concentration of amino-silane, addition of a small amount of an inert dimethylmethoxy-n-octylsilane helps to partially cover the silica surface by inert alkyl groups and helps to tune the grafting density along with preventing aggregation of the particles. To attach the anchoring compound onto the amine functional silica, the 4-cyanopentanioc acid dithiobenzoate can be first activated by using 2-mercaptothiazoline. It can then immobilized onto the surface of silica via a condensation reaction with the amine groups on the silica surface. Using this approach, various CPDB-functionalized particles can be synthesized having a grafting density varying from 0.01-0.7 anchoring compounds/nm². An inherent advantage of this technique compared to the other “grafting-from” methods is the ease and accuracy in measuring the grafting density before carrying out the polymerization. The CPDB molecule is UV-VIS active and hence by comparing the absorption at 302 nm from the CPDB-functionalized particles to a standard absorption curve made from known amounts of free CPDB, the concentration of the anchoring compounds attached onto the particles can be calculated. Knowledge of the concentration of the anchoring compounds attached onto the particles before the reaction provides the reaction with control and predictability, which is the key to controlling molecular weight and molecular weight distribution should those factors prove important for the efficacy of a given fracturing fluid composition.

### 3. Attaching a First Polymeric Chain to the First Anchoring Compound:

Two methods can be utilized to form the first polymeric chain extending from the particles via the first anchoring compound: a “grafting-from” approach and a “grafting-to” approach. These strategies will be explained in more details in the following sections.

A. “Grafting-From” Methods

In one embodiment, the first polymeric chain can be formed by polymerizing a first plurality of first monomers on the first anchoring compound, resulting in the first polymeric chain being covalently bonded to the particle via the first anchoring compound. According to this method, the polymerization of the first polymeric chain can be conducted through any suitable type of polymerization, such as RAFT polymerization, ATRP, etc., which are discussed in greater detail below. The particular types of monomer(s) and/or polymerization technique can be selected based upon the desired polymeric chain to be formed. For example, for RAFT polymerization, monomers containing acrylate, methacrylate groups, acrylamides, styrenics, etc., are particularly suitable for formation of the first polymeric chain. Thus, the “grafting-from” method involves formation of the first polymeric chain onto the first anchoring compound and results in the first polymeric chain being covalently bonded to the particle via the first anchoring compound (and, if present, a first functionalization compound).

B. “Grafting-To” Methods

In one embodiment, the first polymeric chain can be first polymerized and subsequently covalently bonded to the surface of the particle, either directly or via a first anchoring compound (and, if present, a first functionalization compound). Thus, in this embodiment, the first polymeric chain has been polymerized prior to attachment to the first anchoring compound. In this embodiment, the first polymeric chain is not limited to the type of polymerization and/or types of monomer(s) capable of being polymerized directly to the first anchoring compound. As such, as long as the first polymeric chain defines a functional group that can react and bond to the first anchoring compound, any polymeric chain can be bonded to the particle.

C. “Grafting Through” Methods

In another embodiment, a polymerizable monomer bound directly on the surface of the particle is used to initiate the polymerization of many monomers or mixture of monomers, resulting in the attachment of polymer chains to the particle surface. In such polymerization reaction, the surface-attached monomers are incorporated into the growing polymer chains in a “grafting-through” manner, where the polymers are eventually bound to the surface of the particle. According to this method, the polymerization of the first polymeric chain can be conducted through any suitable type of polymerization, such as RAFT polymerization, ATRP, etc. Thus in this embodiment the macromonomer is essentially the functionalized particle.

### 4. Deactivating the First Polymeric Chain:

No matter the method used to attach the first polymeric chain to first anchoring compound on the particle, upon attachment, the first polymeric chain can be deactivated to prevent further polymerization thereon. For example, if the “grafting-from” method was utilized to attach the first polymeric chain to the first anchoring compound via polymerization through a controlled living polymerization (CLP) technique (e.g., RAFT), a deactivation agent can be attached to the end of each polymeric chain to inhibit further polymerization thereon. The deactivation agents can be selected based upon the type of polymerization and/or the type(s) of monomers utilized, but can generally include but are not limited to amines, peroxides, or mixtures thereof. On the other hand, if the “grafting-to” method was utilized to attach the first polymeric chain to the first anchoring compound via attaching a pre-formed first polymeric chain, the first polymeric chain can be deactivated after covalently bonding the first polymeric chain to the first anchoring compound and prior to attaching the second anchoring compound to the particle. Alternatively, the first polymeric chain can be deactivated prior to covalently bonding the first polymeric chain to the first anchoring compound.

### 5. Attaching a Second Anchoring Compound to the Particulate Material:

After attachment and deactivation of the first polymeric chain to the particle, a second anchoring compound can be attached to the remaining surface defined on the particle. This second anchoring compound can be attached via any of the methods described above with respect to the first anchoring compound. The second anchoring compound and/or method of its attachment need not be the same as the first anchoring compound. However, in one particular embodiment, the first anchoring compound and the second anchoring compound are the same.

6. Formation of a Second Polymeric Chain Extending from the Particulate Material:

The second polymeric chain can be attached to the second anchoring compound on the particle via the “grafting-from” method described above with respect to the first polymeric chain. The type(s) of monomers and/or polymerization technique for the formation of the second polymeric chain can be selected independently of the type of first polymeric chain already present on the particle. However, without wishing to be bound by any particular theory, it is presently believed that the use of a “grafting-to” method, which would utilize a pre-formed second polymeric chain, may not be suitable due to the limited access of such a pre-formed polymeric chain to the second anchoring agent on the surface of the particle between the first polymeric chains.

### 7. Additional Polymeric Chains

Additional polymeric chains (e.g., a third polymeric chain, fourth polymeric chain, etc.) can be attached to the particle as desired following the description above with respect to the attachment of the second polymeric chain.

8. Particulate Materials with Multiple Polymeric Assemblies:

According to these methods, particles with multiple polymeric assemblies can be formed that have a first polymeric chain covalently bonded to its surface via a first anchoring compound and a second polymeric chain covalently bonded to its surface via a second anchoring compound. As stated, additional polymeric chains (e.g., a third polymeric chain) can be further attached to the particles.

As used herein, the term “first polymeric chain” is meant to describe a first type of polymeric chain, and one of ordinary skill in the art would recognize that a multiple first polymeric chains could be present on the particle (i.e., a first plurality of first polymeric chains). Likewise, the term “second polymeric chain” is meant to describe a second type of polymeric chain, and one of ordinary skill in the art would recognize that a multiple second polymeric chains could be present on the particle (i.e., a second plurality of second polymeric chains). Even further, the term “third polymeric chain” is meant to describe a third type of polymeric chain, and one of ordinary skill in the art would recognize that a multiple third polymeric chains could be present on the particle (i.e., a third plurality of third polymeric chains).

As stated, the first polymeric chain can be different than the second polymeric chain (e.g., the polymeric first polymeric chain can have a different polydispersity index, molecular weight, etc. than the second polymeric chain). For instance, in one embodiment, the first polymeric chain can have a molecular weight up to 50,000 g/mol (e.g., up to 25,000, up to 10,000, or about 500 to about 50,000 g/mol), and the second polymeric chain can have a molecular weight of about 50,000 g/mol or more. The use of such a relatively small molecular weight for the first polymeric chain can help ensure access to the remaining surface defined on the particle for attachment of the second anchoring compound.

In one embodiment, more first polymeric chains can be attached to the surface of the particle than second polymeric chains.

In another embodiment, a polymerization initiator can be placed on the surface of the particle and used to initiate the polymerization of many monomers or mixture of monomers, resulting in the attachment of polymer chains to the particle surface. Initiators such as peroxides, azo containing compounds, peracetates, photoinitiators and many others known to those skilled in the art can be prepared with one or more functional groups which are capable of reacting with the silica particle surface. Such functional groups include carboxylic acid, silane coupling groups, phosphate groups, and phosphonate groups. The functional groups are reacted with the silica particle surface to attach the initiator to the surface and then added to the polymerization mixture during the polymerization of the monomers. The initiators, already bound to the surface of the particles then initiate chain growth of the monomers. Conventional chain growth polymerization, controlled radical polymerizations, and photochemical initiated polymerizations may be carried out with the initiator-bound particles resulting in the attachment of the polymer chains to the particles.

### Polymerization Techniques

As stated, the first and second polymeric chains can be formed via controlled polymerizations, such as controlled living polymerizations or controlled ring-opening polymerizations, which may be independently selected for each of the first and second polymeric chains based upon the particular anchoring agent present on the particle, type of monomer(s) used to form the polymeric chain, and/or desired properties of the polymeric chains formed. Through the use of these controlled polymerizations, each polymeric chain can be produced with low polydispersity and diverse architectures. Thus, these methods are ideal for block polymer and/or graft polymer synthesis.

Controlled living polymerization generally refers to chain growth polymerization that proceeds with significantly suppressed termination or chain transfer steps. Thus, polymerization in CLP proceeds until all monomer units have been consumed or until the reaction is terminated (e.g., through quenching and/or deactivating), and the addition of monomer results in continued polymerization, making CLP ideal for block polymer and graft polymer synthesis. The molecular weight of the resulting polymer is generally a linear function of conversion so that the polymeric chains are initiated and grow substantially uniformly. Thus, CLPs provide precise control on molecular structures, functionality and compositions. Thus, these polymers can be tuned with desirable compositions and architectures most suitable for optimum performance of the shale hydraulic fracturing fluid.

Controlled living polymerizations can be used to produce block copolymers because CLP can leave a functional terminal group on the polymer formed (e.g., a halogen functional group). For example, in the copolymerization of two monomers (A and B) allowing A to polymerize via CLP will exhaust the monomer in solution with minimal termination. After monomer A is fully reacted, the addition of monomer B will result in a block copolymer. Controlled ring-opening polymerizations can utilize suitable catalysts such as tin-derived catalysts to open the rings of monomers to form a polymer. Several of such polymerization techniques are discussed in this application. These techniques are generally known to those skilled in the art. A brief general description of each technique is below, and is provided for further understanding of the present invention, and is not intended to be limiting:

A. Reversible Addition-Fragmentation Chain Transfer Polymerization

Reversible Addition-Fragmentation chain Transfer polymerization is one type of controlled radical polymerization. RAFT polymerization uses thiocarbonylthio compounds, such as dithioesters, dithiocarbamates, trithiocarbonates, and xanthates, in order to mediate the polymerization via a reversible chain-transfer process. RAFT polymerization can be performed by simply adding a chosen quantity of appropriate RAFT agents (thiocarbonylthio compounds) to a conventional free radical polymerization. RAFT polymerization is particularly useful with monomers having a vinyl functional group (e.g., a (meth)acrylate group). Typically, a RAFT polymerization system includes the monomer, an initiator, and a RAFT agent (also referred to as a chain transfer agent). Because of the low concentration of the RAFT agent in the system, the concentration of the initiator is usually lower than in conventional radical polymerization. Suitable radical initiators can be azobisisobutyronitrile (AIBN), 4,4′-azobis(4-cyanovaleric acid) (ACVA), etc. RAFT agents are generally thiocarbonylthio compounds, such as generally shown below:

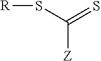

where the Z group primarily stabilizes radical species added to the C═S bond and the R group is a good homolytic leaving group which is able to initiate monomers. For example, the Z group can be an aryl group (e.g., phenyl group, benzyl group, etc.), an alkyl group, an alkoxy group, a substituted amine group, etc.

As stated, RAFT is a type of living polymerization involving a conventional radical polymerization in the presence of a reversible chain transfer reagent. Like other living radical polymerizations, there is minimized termination step in the RAFT process. The reaction is started by radical initiators (e.g., AIBN or peroxides). In this initiation step, the initiator reacts with a monomer unit to create a radical species that starts an active polymerizing chain. Then, the active chain reacts with the thiocarbonylthio compound, which ejects the homolytic leaving group (R). This is a reversible step, with an intermediate species capable of losing either the leaving group (R) or the active species. The leaving group radical then reacts with another monomer species, starting another active polymer chain. This active chain is then able to go through the addition-fragmentation or equilibration steps. The equilibration keeps the majority of the active propagating species into the dormant thiocarbonyl compound, limiting the possibility of chain termination. Thus, active polymer chains are in equilibrium between the active and dormant species. While one polymer chain is in the dormant stage (bound to the thiocarbonyl compound), the other is active in polymerization. By controlling the concentration of initiator and thiocarbonylthio compound and/or the ratio of monomer to thiocarbonylthio compound, the molecular weight of the polymeric chains can be controlled with low polydispersities.

Depending on the target molecular weight of final polymers, the monomer to RAFT agent ratios can range from about less than about 10 to more than about 10,000 (e.g., about 10 to about 5,000). Other reaction parameters can be varied to control the molecular weight of the final polymers, such as solvent selection, reaction temperature, and reaction time. For instance, solvents can include conventional organic solvents such as tetrahydrofuran, toluene, dimethylformamide, anisole, acetonitrile, dichloromethane, aqueous media, etc. The reaction temperature can range from room temperature (e.g., about 20° C.) to about 120° C. The reaction time can be from less than about 1 h to about 72 h. The RAFT process allows the synthesis of polymers with specific macromolecular architectures such as block, gradient, statistical, comb/brush, star, hyperbranched, and network copolymers although the simplest structures will likely suffice for application in a shale fracturing fluid.

Nevertheless, because RAFT polymerization is a form of living radical polymerization, it is ideal for synthesis of block copolymers. For example, in the copolymerization of two monomers (A and B), allowing A to polymerize via RAFT will exhaust the monomer in solution with significantly suppressed termination. After monomer A is fully reacted, the addition of monomer B will result in a block copolymer. One requirement for maintaining a narrow polydispersity in this type of copolymer is to have a chain transfer agent with a high transfer constant to the subsequent monomer (monomer B in the example). Using a multifuntional RAFT agent can result in the formation of a star copolymer. RAFT differs from other forms of CLPs because the core of the copolymer can be introduced by functionalization of either the R group or the Z group. While utilizing the R group results in similar structures found using ATRP or NMP, the use of the Z group makes RAFT unique. When the Z group is used, the reactive polymeric arms are detached from the core while they grow and react back into the core for the chain-transfer reaction.

B. Atom Transfer Radical Polymerization

Atom transfer radical polymerization (ATRP) is another example of a living radical polymerization. The control is achieved through an activation-deactivation process, in which most of the reaction species are in dormant format, thus significantly reducing chain termination reaction. The four major components of ATRP include the monomer, initiator, ligand, and catalyst. ATRP is particularly useful monomers having a vinyl functional group (e.g., a (meth)acrylate group). Organic halides are particularly suitable initiators, such as alkyl halides (e.g., alkyl bromides, alkyl chlorides, etc.). For instance, in one particular embodiment, the alkyl halide can be ethyl 2-bromoisobutyrate. The shape or structure of the initiator can also determine the architecture of the resulting polymer. For example, initiators with multiple alkyl halide groups on a single core can lead to a star-like polymer shape.

The catalyst can determine the equilibrium constant between the active and dormant species during polymerization, leading to control of the polymerization rate and the equilibrium constant. In one particular embodiment, the catalyst is a metal having two accessible oxidation states that are separated by one electron, and a reasonable affinity for halogens. One particularly suitable metal catalyst for ATRP is copper (I). The ligands can be linear amines or pyridine-based amines.

Depending on the target molecular weight of final polymers, the monomer to initiator ratios can range from less than about 10 to more than about 1,000 (e.g., about 10 to about 1,000). Other reaction parameters can be varied to control the molecular weight of the final polymers, such as solvent selection, reaction temperature, and reaction time. For instance, solvents can include conventional organic solvents such as tetrahydrofuran, toluene, dimethylformamide, anisole, acetonitrile, dichloromethane, etc. The reaction temperature can range from room temperature (e.g., about 20° C.) to about 12° C. The reaction time can be from less than about 1 h to about 48 h.

C. Nitroxide-Mediated Polymerization

Nitroxide-mediated polymerization (NMP) is another form of controlled living polymerization utilizing a nitroxide radical, such as shown below:

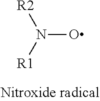

where R1 and R2 are, independently, organic groups (e.g., aryl groups such as phenyl groups, benzyl groups, etc.; alkyl groups, etc.). NMP is particularly useful with monomers having a vinyl functional group (e.g., a (meth)acrylate group).

D. Ring-Opening Metathesis Polymerization

Ring-opening metathesis polymerization (ROMP) is a type of olefin metathesis polymerization. The driving force of the reaction is relief of ring strain in cyclic olefins (e.g. norbornene or cyclopentene) in the presence of a catalyst. The catalysts used in a ROMP reaction can include a wide variety of metals and range from a simple RuCl₃/alcohol mixture to Grubbs' catalyst. In this embodiment, the monomer can include a strained ring functional group, such as a norbornene functional group, a cyclopentene functional group, etc. to form the polymeric chains. For example, norbornene is a bridged cyclic hydrocarbon that has a cyclohexene ring bridged with a methylene group in the para position.

The ROMP catalytic cycle generally requires a strained cyclic structure because the driving force of the reaction is relief of ring strain. After formation of the metal-carbene species, the carbene attacks the double bond in the ring structure forming a highly strained metallacyclobutane intermediate. The ring then opens giving the beginning of the polymer: a linear chain double bonded to the metal with a terminal double bond as well. The new carbene reacts with the double bond on the next monomer, thus propagating the reaction.

E. Ring-Opening Polymerization

In one particular embodiment, where the monomer includes a strained ring function group (e.g., a caprolactone or lactide), ring-opening polymerization (ROP) may be used to form the polymeric chain. For example, a caprolcatone-substituted monomer is a polymerizable ester, which can undergo polymerization with the aid of an alcohol as an initiator and a tin-based reagent as a catalyst.

### EXAMPLES

### 1. Synthesis of CPDB Anchored Silica Particles

A solution (10 ml) of colloidal silica particles (30 wt % in MIBK, Nissan Chemical, 15 nm diameter) was added to a two necked round-bottom flask and diluted with 75 ml of THF. To it was added 3-aminopropyldimethylethoxysilane (0.16 ml, 1 mmol) and the mixture was refluxed at 75° C. overnight under nitrogen protection. The reaction was then cooled to room temperature and precipitated in large amount of hexanes. The particles were then recovered by centrifugation and dispersed in THF using sonication and precipitated in hexanes again. The amino functionalized particles were then dispersed in 40 ml of THF for further reaction.

A THF solution of the amino functionalized silica particles (40 ml, 1.8 g) was added drop wise to a THF solution (30 ml) of activated CPDB (0.25 g, 0.65 mmol) at room temperature. After complete addition, the solution was stirred overnight. The reaction mixture was then precipitated into a large amount of 4:1 mixture of cyclohexane and ethyl ether (2500 ml). The particles were recovered by centrifugation at 3000 rpm for 8 minutes. The particles were then re-dispersed in 30 ml THF and precipitated in 4:1 mixture of cyclohexane and ethyl ether. This dissolution-precipitation procedure was repeated 2 more times until the supernatant layer after centrifugation was colorless. The red CPDB anchored silica particles were dried at room temperature and analyzed using UV analysis for the chain density. Several such CPDB anchored silica particles having different grafting density from 0.05 to 0.6 chains/nm² were prepared by adjusting the ratio of the 3-aminopropyldimethylethoxysilane to colloidal silica particles.

### 2. Synthesis of Bimodal Silica Grafted Polymethylmethacrylate (PMMA) Particles by Step-by-Step RAFT Polymerization

A. Graft Polymerization of Methyl Methacrylate Monomer from CPDB Anchored Colloidal Silica Particles to Graft 1^{st} Chain from Surface of Particles

A solution of methyl methacrylate (7 mL), CPDB anchored silica particles (300 mg, 80 μmol/g), AIBN (2.40 μmol), and THF (7 mL) was prepared in a dried Schlenk tube. The mixture was degassed by three freeze-pump-thaw cycles, back filled with nitrogen, and then placed in an oil bath at 60° C. for 3 h. The polymerization solution was quenched in ice water and poured into cold methanol to precipitate polymer grafted silica particles. The polymer chains were cleaved by treating a small amount of particles with HF and the resulting polymer chains were analyzed by GPC. The polymer cleaved from the Si-g-PMMA particles had a molecular weight of 24,400 g/mol and PDI of 1.07.

B. Cleavage of RAFT Agent from 1^{st} Brush:

Solid AIBN (24 μmol) was added to a solution of Si-g-PMMA in THF (0.4 g in 20 ml) and heated at 65° C. under nitrogen for 30 minutes. The resulting white solution mixture was poured into 100 ml hexanes and centrifuged at 8000 rpm for 5 minutes to recover Si-g-PMMA particles.

C. Functionalization of Si-g-PMMA by 2^{nd} RAFT Agent:

The second RAFT agent was attached onto the surface of the silica which was not covered by the first polymer chain. The remaining bare surface of the particles was functionalized by amine groups using 0.01 ml of 3-aminopropyldimethylethoxysilane in a process similar to the first RAFT agent attachment. The second RAFT agent was attached by reaction of 30 mg of activated CPDB (0.030 g) at room temperature with the amino-functional particles.

D. Graft Polymerization of Methyl Methacrylate from Si-g-PMMA to Synthesize 2^{nd} Brush:

The CPDB anchored Si-g-PMMA particles (0.4 g) dissolved in 10 mL THF were added to a dried Schlenk tube along with 15 ml MMA and AIBN (45 μl of 0.005M THF solution). The mixture was degassed by three freeze-pump-thaw cycles, back filled with nitrogen, and then placed in an oil bath at 65° C. for 12 hours. The polymerization was quenched in ice water. The polymer was recovered by precipitating into hexane and centrifugation at 8000 rpm. GPC results indicated the 2^{nd} chain has a molecular weight of 103,000 g/mol and PDI of 1.13.

### 3. Synthesis of Bimodal Silica Grafted Polystyrene (PS) Particles by Step-by-Step RAFT Polymerization

A. Graft Polymerization of Styrene from CPDB Anchored Colloidal Silica Particles to Graft 1^{st} Chain from Surface of Particles:

A solution of styrene (25 ml), CPDB anchored silica particles (1.4 g, 80 μmol/g), AIBN (1.8 ml, 5 mM solution in THF), and THF (25 ml) was prepared in a dried Schlenk tube. The mixture was degassed by three freeze-pump-thaw cycles, back filled with nitrogen, and then placed in an oil bath at 65° C. for 4 hours. The polymerization solution was quenched in ice water and poured into cold methanol to precipitate polymer grafted silica particles. The polymer chains were cleaved by treating a small amount of particles with HF and the resulting polymer chains were analyzed by GPC. The polymer cleaved from the Si-g-PS particles had a molecular weight of 1600 g/mol and PDI of 1.26.

B. Cleavage of RAFT Agent from 1^{st} Brush:

Solid AIBN (250 mg) was added to a solution of Si-g-PS in THF (2g in 50 ml) and heated at 65° C. under nitrogen for 30 minutes. The resulting white solution mixture was poured into 200 ml hexanes and centrifuged at 8000 rpm for 5 minutes to recover Si-g-PS particles.

C. Functionalization of Si-g-PS by 2^{nd} RAFT Agent:

The second RAFT agent was attached onto the surface of the silica which was not covered by the first polymer chain. The bare surface of the particles was functionalized by amine groups using 0.01 ml of 3-aminopropyldimethylethoxysilane in a process similar to the first RAFT agent attachment. The second RAFT agent was attached by reaction 30 mg of activated CPDB (0.030 g) at room temperature with the amino-functional particles.

D. Graft Polymerization of Styrene from Si-g-PS to Synthesize 2^{nd} Brush:

The CPDB anchored Si-g-PS particles (1.4 g by weight of bare silica) dissolved in 10 ml THF were added to a dried Schlenk tube along with 20 ml styrene and AIBN (1.8 mL of 0.005M THF solution). The mixture was degassed by three freeze-pump-thaw cycles, back filled with nitrogen, and then placed in an oil bath at 65° C. for 18 hours. The polymerization was quenched in ice water. The polymer was recovered by precipitating into hexane and centrifugation at 8000 rpm. GPC results indicated the 2^{nd} chain has a molecular weight of 40,000 g/mol and PDI of 1.19.

### 4. Synthesis of Mixed Brush of Polystyrene and Polymethylmethacrylate (PMMA) Grafted Silica Particles by Step-by-Step RAFT Polymerization

A. Graft Polymerization of Styrene from CPDB Anchored Colloidal Silica Particles to Graft 1^{st} Chain from Surface of Particles:

A solution of styrene (10 ml), CPDB anchored silica particles (0.5 g, 80 μmol/g), AIBN (0.600 ml, 5 mM solution in THF), and THF (10 ml) was prepared in a dried Schlenk tube. The mixture was degassed by three freeze-pump-thaw cycles, back filled with nitrogen, and then placed in an oil bath at 65° C. for 4 hours. The polymerization solution was quenched in ice water and poured into cold methanol to precipitate polymer grafted silica particles. The polymer chains were cleaved by treating a small amount of particles with HF and the resulting polymer chains were analyzed by GPC. The polymer cleaved from the Si-g-PS particles had a molecular weight of 5000 g/mol and PDI of 1.13.

B. Cleavage of RAFT Agent from 1^{st} Brush:

Solid AIBN (108 mg) was added to a solution of Si-g-PS in THF (0.5 g in 50 ml) and heated at 65° C. under nitrogen for 30 minutes. The resulting white solution mixture was poured into 200 ml hexanes and centrifuged at 8000 rpm for 5 minutes to recover Si-g-PS particles.

C. Functionalization of Si-g-PS by 2^{nd} RAFT Agent:

The second RAFT agent was attached onto the surface of the silica which was not covered by the first polymer chain. The bare surface of the particles was functionalized by amine groups using 0.0025 ml of 3-aminopropyldimethylethoxysilane in a process similar to the first RAFT agent attachment. The second RAFT agent was attached by reaction 30 mg of activated CPDB (0.030 g) at room temperature with the amino-functional particles.

D. Graft Polymerization of Methyl Methacrylate from Si-g-PS to Synthesize 2^{nd} Brush:

The CPDB anchored Si-g-PS particles (0.5 g by weight of bare silica) dissolved in 10 mL THF were added to a dried Schlenk tube along with 20 ml methyl methacrylate and AIBN (0.01 ml of 0.005M THF solution). The mixture was degassed by three freeze-pump-thaw cycles, back filled with nitrogen, and then placed in an oil bath at 60° C. for 14 hours. The polymerization was quenched in ice water. The polymer was recovered by precipitating into hexane and centrifugation at 8000 rpm. GPC results indicated the 2^{nd} chain has a molecular weight of 205,000 g/mol and PDI of 1.17.

### 5. Synthesis of Mixed Brush of Polymethyl Methacrylate and Poly(t-Butyl Methacrylate) Grafted Silica Particles by Step-by-Step RAFT Polymerization

A. Graft Polymerization of Methyl Methacrylate from CPDB Anchored Colloidal Silica Particles to Graft 1^{st} Chain from Surface of Particles:

A solution of methyl methacrylate (10 mL), CPDB anchored silica particles (0.5 g, 80 μmol/g), AIBN (0.600 ml, 5 mM solution in THF), and THF (10 mL) was prepared in a dried Schlenk tube. The mixture was degassed by three freeze-pump-thaw cycles, back filled with nitrogen, and then placed in an oil bath at 60° C. for 3 hours. The polymerization solution was quenched in ice water and poured into cold methanol to precipitate polymer grafted silica particles. The polymer chains were cleaved by treating a small amount of particles with HF and the resulting polymer chains were analyzed by GPC. The polymer cleaved from the Si-g-PMMA particles had a molecular weight of 5000 g/mol and PDI of 1.17.

B. Cleavage of RAFT Agent from 1^{st} Brush:

Solid AIBN (108 mg) was added to a solution of Si-g-PMMA in THF (0.5 g in 50 ml) and heated at 65° C. under nitrogen for 30 minutes. The resulting white solution mixture was poured into 100 ml hexanes and centrifuged at 8000 rpm for 5 minutes to recover Si-g-PMMA particles.

C. Functionalization of Si-g-PS by 2^{nd} RAFT Agent:

The second RAFT agent was attached onto the surface of the silica which was not covered by the first polymer chain. The bare surface of the particles was functionalized by amine groups using 0.0025 ml of 3-aminopropyldimethylethoxysilane in a process similar to the first RAFT agent attachment. The second RAFT agent was attached by reaction 30 mg of activated CPDB (0.030 g) at room temperature with the amino-functional particles.

D. Graft Polymerization of t-Butyl Methacrylate from Si-g-PMMA to Synthesize 2^{nd} Brush:

The CPDB anchored Si-g-PMMA particles (0.105 g) dissolved in 7 ml THF were added to a dried Schlenk tube along with 0.500 ml t-butyl methacrylate and AIBN (10 μl of 0.005M THF solution). The mixture was degassed by three freeze-pump-thaw cycles, back filled with nitrogen, and then placed in an oil bath at 65° C. for 12 hours. The polymerization was quenched in ice water. The polymer was recovered by precipitating into hexane and centrifugation at 8000 rpm. GPC results indicated the 2^{nd} chain has a molecular weight of 17,000 g/mol and PDI of 1.24.

### 6. Synthesis of Bimodal Polystyrene Brush Grafted Silica Particles by Step-by-Step RAFT and ATRP Polymerization

A. Graft Polymerization of Styrene from CPDB Anchored Colloidal Silica Particles to Graft 1^{st} Chain from Surface of Particles:

A solution of styrene (10 ml), CPDB anchored silica particles (0.3 g, 80 μmol/g), AIBN (0.240 ml, 5 mM solution in THF), and THF (10 ml) was prepared in a dried Schlenk tube. The mixture was degassed by three freeze-pump-thaw cycles, back filled with nitrogen, and then placed in an oil bath at 65° C. for 4 hours. The polymerization solution was quenched in ice water and poured into cold methanol to precipitate polymer grafted silica particles. The polymer chains were cleaved by treating a small amount of particles with HF and the resulting polymer chains were analyzed by GPC. The polymer cleaved from the Si-g-PS particles had a molecular weight of 10,400 g/mol and PDI of 1.12.

B. Cleavage of RAFT Agent from 1^{st} Brush:

Solid AIBN (110 mg) was added to a solution of Si-g-PS in THF (0.5 g in 50 ml) and heated at 65° C. under nitrogen for 30 minutes. The resulting white solution mixture was poured into 100 ml hexanes and centrifuged at 8000 rpm for 5 minutes to recover Si-g-PS particles.

C. Functionalization of Si-g-PS by ATRP Initiator Agent:

The ATRP initiator was attached onto the surface of the silica which was not covered by the first polymer chain. A solution (0.3 g by weight of silica) of Si-g-PS was added to a two-necked round-bottom flask and diluted with 25 ml of THF. To it was added 0.025 ml of 3-trimethoxysilylpropyl-2-bromo-2-methylpropionate and the mixture was refluxed at 75° C. overnight under nitrogen protection. The reaction was then cooled to room temperature and precipitated in large amount of hexanes. The particles were then recovered by centrifugation and dispersed in THF using sonication and precipitated in hexanes again. The ATRP initiator functionalized particles were then dispersed in 10 ml of THF for further reaction.

D. ATRP Polymerization of Styrene from Si-g-PS to Synthesize 2^{nd} PS Brush:

The styrene monomer (10 ml), Cu(I)Cl (0.189 mmol) and Me₆Tren ligand (0.38 mmol) was added to a Schlenk flask and degassed by purging nitrogen for 10 minutes. In another flask ATRP initiator anchored Si-g-PS particles (0.3 g by weight of silica) were dissolved in 10 mL THF and the solution was degassed using nitrogen for 10 minutes. The particle solution was then added to the Schlenk flask and the Schlenk flask was then placed in an oil bath at 90° C. for 36 hours. The polymerization was quenched in ice water. The polymer was recovered by precipitating into methanol and centrifugation at 8000 rpm, followed by redispersion in THF. The process was repeated 4 more times to remove the copper catalyst. GPC results indicated the 2^{nd} chain has a molecular weight of 255,000 g/mol and PDI of 1.43.

### UV Analysis

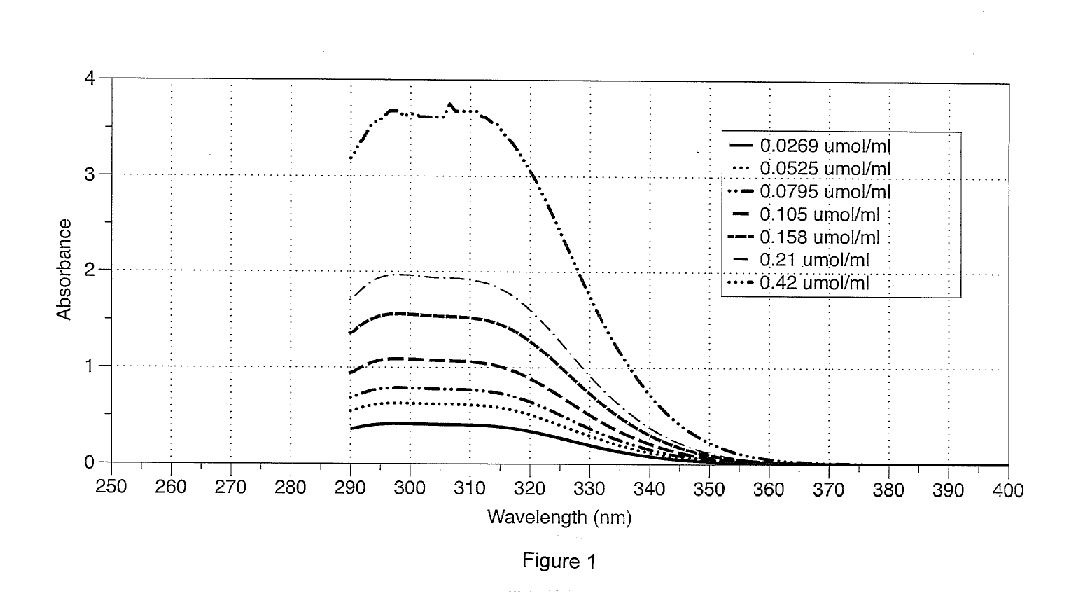

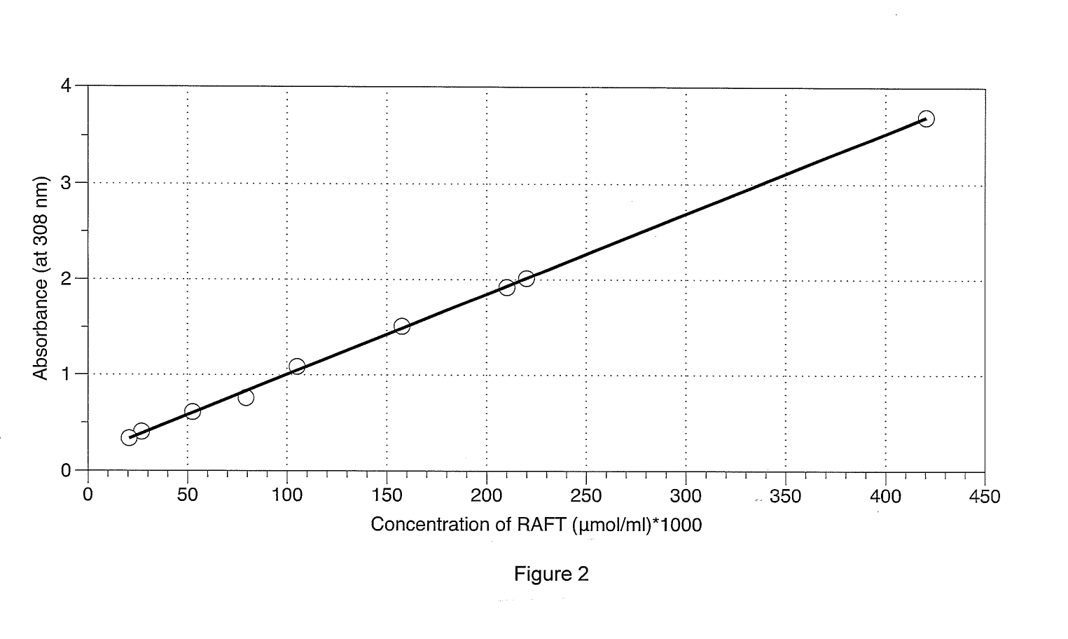

In order to calculate grafting densities of RAFT agents on Syloid (silica particles, Grace Chemical, average diameter 3.2 microns) particles, a calibration curve was made using the absorbance of the RAFT agent at wavelength=308 nm at a range of 0.0269 μmol/ml to 0.42 μmol/ml (FIG. 1). The calibration curve in FIG. 2 was used to determine the concentration of RAFT agents on Syloid (silica) based on the absorbance of the particular Syloid-RAFT sample at 308 nm. Concentrations are presented as μmol of RAFT/g of Syloid.

### 1.1 Synthesis of an Activated Trithiocarbonate

4-Cyano-4-(dodecylsulfanylthiocarbonyl)sulfanylpentanoic acid (CTD) (1 g, 2.48 mmol), 2-mercaptothiazoline (0.295 g, 2.48 mmol), and dicyclohexylcarbodiimide (DCC) (0.613 g, 2.97 mmol) were dissolved in 20 ml of dichloromethane. (Dimethylamino)pyridine (DMAP) (30 mg, 0.25 mmol) was added slowly to the solution under ice, which was stirred at room temperature overnight under nitrogen. The solution was filtered to remove the salt. After silica gel column chromatography (5:4 mixture of hexane and ethyl acetate) and removal of solvent, the activated trithiocarbonate was obtained as a yellow oil.

### 1.2 Preparation of Amino-Functionalized Syloid

A suspension of Syloid (silica) particles (2.0 g) in THF (20 ml) was added to a three-necked round-bottom flask with 3-aminopropyldimethylethoxysilane (0.60 μL) and THF (80 ml). The reaction mixture was heated at 75° C. under N₂ protection overnight and then cooled to room temperature. The reaction mixture was precipitated into a large amount of hexanes (500 ml, ACS Reagent). The particles were recovered by centrifugation at 3000 rpm for 15 min. The particles were then redissolved in 20 mL of THF and reprecipitated in 100 mL of hexanes. The amino functionalized particles were dispersed directly into 50 mL of THF and used directly for the next modification.

### 1.3 Preparation of Trithiocarbonate Anchored Syloid

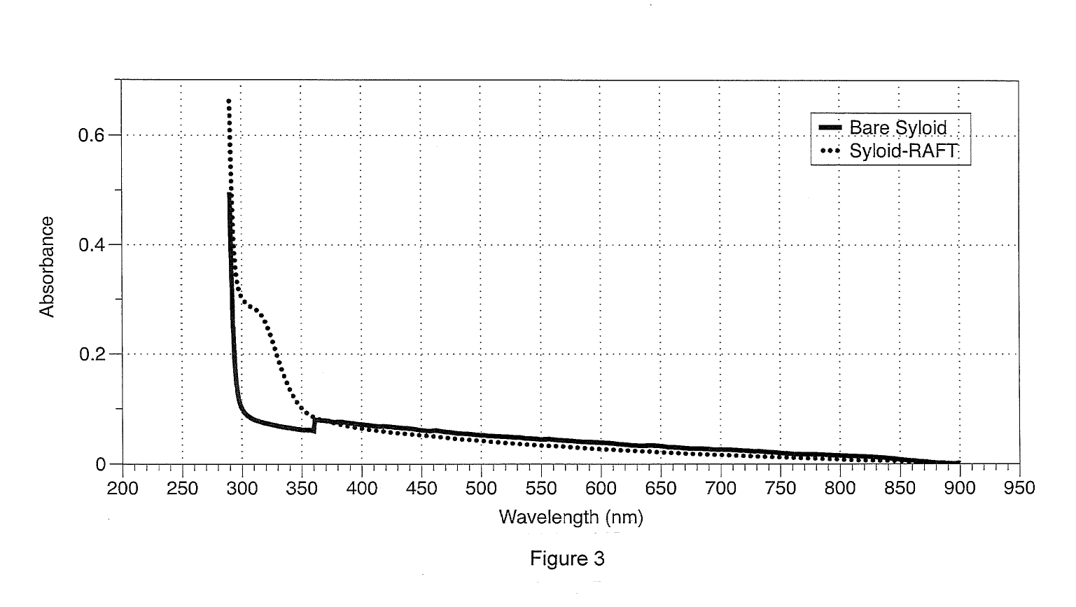

A THF solution (20 ml) of the high surface density amino-functionalized Syloid (1.8 g, 0.319 mmol of anime groups) was added dropwise to a THF solution (10 ml) of activated CTD (0.18 g, 0.351 mmol) at 0° C. After complete addition, the solution was stirred overnight at room temperature under nitrogen. The reaction mixture was then precipitated into a large amount of 4:1 mixture of cyclohexane and ethyl ether (200 ml). The particles were recovered by centrifugation at 3000 rpm for 15 min. The particles were then redissolved in 20 mL of THF and reprecipitated in 4:1 mixture of cyclohexane and ethyl ether. This dissolution-precipitation procedure was repeated another two times until the supernatant layer after centrifugation was colorless. The Syloid particles were dried under vacuum for 1 hr and subjected to analysis by UV to determine the graft density (FIG. 3). The particles had a density of 36.26 μmol/g.

1.4 Acrylamide Graft Polymerization from Trithiocarbonate Anchored Syloid

RAFT agent anchored Syloid (0.050 g, 36.36 μmol/g), dimethylsulfoxide (DMSO) (3 ml), acrylamide (AM) (0.5 g, 6.94 mmol) and trioxane (25 mg, internal standard) were added to a 15 mL Schlenk tube followed by sonication and addition of AIBN (69 μL of 10 mM DMSO solution). The tubes were subjected to three cycles of freeze-pump-thaw to remove oxygen. They were then placed in an oil bath preset to 70° C. for various intervals. The polymerizations were stopped by quenching the tubes in ice water, and the polymerization mixtures were precipitated into acetone. The polymer was collected by centrifugation of the acetone mixture at 3000 rpm for 5 min. Nuclear magnetic resonance (NMR) analysis of the reaction mixture were taken both prior to and directly after the polymerization to calculate conversion. A monomer conversion of 34% was reached after 23 h.

1.5 General Procedures for Cleaving Grafted Polymer from Syloid

100 mg of polyacrylamide (PAM) grafted Syloid particles was dissolved in 3 mL of DMSO. Aqueous HF (49%, 0.2 ml) was added, and the solution was allowed to stir at room temperature overnight. The solution was poured into a PTFE Petri dish and allowed to stand in a fume hood overnight to evaporate the volatiles. The recovered PAM was subjected to analysis by NMR.

### 2.1 Preparation of CPDB Anchored Syloid

Activated CPDB was prepared as outlined in the literature,¹ and was attached in a similar fashion as described in procedure 1.3. Grafting densities of CPDB on the syloid particles ranged from 60-142 μmol/g.

2.2 Graft Polymerization of Acrylic Acid from CPDB Anchored Syloid

In a dried Schlenk tube, CPDB anchored Syloid (0.50 g, 30.56 μmol/g) was dissolved in DMF (14 ml). Acrylic acid (13.84 ml) and AIBN (152 μL, 0.01M in DMF) were then added to the tube. The mixture was degassed by three freeze-pump-thaw cycles, back filled with nitrogen, and then placed in an oil bath preset at 65° C. The polymerization was quenched by submersion of the reaction vessel in ice water. The polymer solution was precipitated into ether, and redispersed in DMF. The precipitation-redispersion process was repeated once more.

3.1 Preparation of Poly(PEG-co-NMS)

In a dried Schlenk flask, CTD (0.005 g, 0.0124 mmol) was dissolved in DMF (0.127 ml). To this solution was added N-methacryloxy succinimide (NMS) (0.034 g, 0.186 mmol), PEG-methacrylate (Mn: 500 g/mol), 0.093 g, 0.1858 mmoles) and AIBN (310 μL, 0.01M in DMF). The mixture was degassed by three freeze-pump-thaw cycles, back filled with nitrogen, and then placed in an oil bath preset at 65° C. The polymerization was quenched by submersion of the reaction vessel in ice water. The polymer solution was precipitated into ether, and redispersed in DMF. The precipitation-redispersion process was repeated once more to obtain Poly(PEG-co-NMS) with Mn: 17,687 g/mol and PDI of 1.27.

### 3.2 Grafting-To Procedure for PEG Functionalized Syloid

Amine functionalized Syloid (82.5 mg, 136.6 μmol/g) was dispersed in THF (2 ml) in a round bottom flask, followed by the addition of triethylamine (17.1 mg, 0.17 mmol). The mixture was purged with nitrogen for 10 min, and the Poly(PEG-co-NMS) (17,687 g/mol, 0.845 mmol of NMS) in 1 ml THF was added via a syringe. The flask was attached to a condenser, purged for 10 min, and then stirred at 70° C. overnight. The mixture were diluted with THF (10 ml) and then centrifuged at 3000 rpm for 5 min. The particles were recovered and then dried under vacuum for 2 h. The particles were subjected to NMR analysis, where the presence of PEG and lack of signal from the succinimide group confirmed attachment of the polymer to the Syloid particles.

### Preparation of Poly(PAM-co-NMS)

In a dried Schlenk flask, CTD (0.005 g, 0.0124 mmol) was dissolved in DMSO (0.8 ml). To this solution was added N-methacryloxy succinimide (0.0566 g, 0.309 mmol), acrylamide (0.089 g, 1.23 mmol) and AIBN (246 μL, 0.01M in DMSO). The mixture was degassed by three freeze-pump-thaw cycles, back filled with nitrogen, and then placed in an oil bath preset at 70° C. The polymerization was quenched by submersion of the reaction vessel in ice water. The polymer solution was precipitated into acetone, and redispersed in H₂0. The precipitation-redispersion process was repeated once more to obtain Poly(PAM-co-NMS) with conversions of 47.83% and 80.1% for the NMS and acrylamide respectively. The Mn of the polymer was confirmed to be 15,345 g/mol with a PDI of 1.24.

### 3.2 Grafting-To Procedure for PAM Functionalized Syloid

Amine functionalized Syloid (82.5 mg, 136.6 μmol/g) was dispersed in THF (2 ml) in a round bottom flask, followed by the addition of triethylamine (17.1 mg, 0.17 mmol). The mixture was purged with nitrogen for 10 min, and the Poly(PAM-co-NMS) in 2 ml THF was added via a syringe. The flask was attached to a condenser, purged for 10 min, and then stirred at 70° C. overnight. The mixture was diluted with acetone (10 ml) and then centrifuged at 3000 rpm for 5 min. The particles were recovered and then dried under vacuum for 2 h. The particles were subjected to NMR analysis, where the presence of PAM and lack of signal from the succinimide group confirmed attachment of the polymer to the Syloid particles.

### 4.1 Filtration Procedure

Filter columns were made with a plug of cotton, sand (1 mm) and filter material (4 cm) in a Fisherbrand™ Disposable Borosilicate Glass Pasteur Pipette (length: 5.75 in., 146 mm). Filter materials used include Syloid particles, silica gel (70-200 μm), and diatomaceous earth. A typical method involved the dissolution of the sample in water (1 ml) and its addition to the column to be filtered into a vial. The vial was then freeze-dried to calculate the mass of its contents. All experiments involved three sets of samples including the control (1 ml of water), free polymer (for PAA, Mn:1800 g/mol) and Syloid-polymer. Retention efficiencies were calculated based on the amount of Syloid-polymer and free polymer had passed through the column compared to the original amounts of each used. A retention efficiency of 0% for the free polymer indicated that all the free polymer had passed through the column. Conversely, a retention efficiency of 100% for the Syloid-polymer indicated that none of the Syloid-polymer had passed through the column.

### 4.2 Filtration Procedure (Extended Wash)

In order to simulate real world conditions, extended washing procedures were tested to see the retention efficiency after several additions of water to the column. In this procedure, samples were dissolved in water (2 ml), passed through the column, and followed up with two separate additions of water (1 ml) each. Similar to the procedure outlined above, each experiment included a control (2 ml of water), and the free polymer and Syloid-polymer respectively.

### Results

4.2.1

TABLE 1
Syloid-PAA (Mn: 140,000 g/mol), water (1 ml), Filter
(Diatomaceous Earth)

| | Amount | Amount After | Efficiency | Adjusted |
|---|---|---|---|---|
| | Used (mg) | Filtration (mg) | (%) | Efficiency (5) |
| Control | — | 1 | | |
| PAA only | 15 | 8 | 46.7 | 53.3 |
| Syloid-PAA | 15 | 1 | 93.3 | 100 |

Polyacrylic acid of 140,000 g/mol on Syloid silica particles prepared by grafting-from techniques was tested by the procedures outlined in section 4.1. The adjusted efficiency data showed that 53.3% of the free polymer was retained in the column, as compared to 100% retention of the Syloid-polymer in the diatomaceous earth.

4.2.2

TABLE 2
Syloid-PAA (Mn: 200,000 g/mol), water (1 ml), Filter
(Diatomaceous Earth)

| | Amount | Amount After | Retention | Adjusted |
|---|---|---|---|---|
| | Used (mg) | Filtration (mg) | Efficiency (%) | Efficiency (5) |
| Control | — | 0.05 | | |
| PAA | 22 | 8 | 63.63 | 65.9 |
| Syloid- | 22 | 1.5 | 93.1 | 95.4 |
| PAA | | | | |

Polyacrylic acid of 200,000 g/mol on Syloid silica particles prepared by grafting-from techniques was tested by the procedures outlined in section 4.1. The adjusted efficiency data showed that 65.9% of the free polymer was retained in the column, as compared to 95.4% retention of the Syloid-polymer in the diatomaceous earth.

4.2.3

TABLE 3
Syloid-PAA (Mn: 140,000 g/mol), water (2 ml), Extended wash
with water (2 ml), Filter (Diatomaceous Earth)

| | Amount | Amount After | Retention | Adjusted |
|---|---|---|---|---|
| | Used (mg) | Filtration (mg) | Efficiency (%) | Efficiency (%) |
| Control | — | 0.5 | | |
| PAA | 14 | 13.6 | 2.85 | 6.4 |
| Syloid- | 13 | 2 | 84.6 | 88.46 |
| PAA | | | | |

Polyacrylic acid of 140,000 g/mol on Syloid silica particles prepared by grafting-from techniques was tested by the procedures outlined in section 4.2.1. The adjusted efficiency data showed that 6.4% of the free polymer was retained in the column, as compared to 88.46% retention of the Syloid-polymer in the diatomaceous earth.

4.2.4

TABLE 4
Syloid-PAA (Mn: 200,000 g/mol), water (2 ml), Extended
wash with water (2 ml), Filter (Diatomaceous Earth)

| | Amount | Amount After | Retention | Adjusted |
|---|---|---|---|---|
| | Used (mg) | Filtration (mg) | Efficiency (%) | Efficiency (%) |
| Control | — | 0.1 | | |
| PAA | 16 | 15.5 | 3.1 | 3.75 |
| Syloid- | 16 | 2.7 | 83.1 | 83.7 |
| PAA | | | | |

Polyacrylic acid of 200,000 g/mol on Syloid silica particles prepared by grafting-from techniques was tested by the procedures outlined in section 4.2.1. The adjusted efficiency data showed that 3.75% of the free polymer was retained in the column, as compared to 83.7% retention of the Syloid-polymer in the diatomaceous earth.

4.2.5

TABLE 5
Syloid-PEG (Grafted-to. Mn: 17,687 g/mol, PDI: 1.27), PEG-co-NMS
(Mn: 38,888, PDI: 1.46), water (2 ml), Extended wash with water
(2 ml), Filter (Diatomaceous Earth)

| | | Amount | | Adjusted |
|---|---|---|---|---|
| | Amount | After | Retention | Efficiency |
| | Used (mg) | Filtration (mg) | Efficiency (%) | (%) |
| Control | — | 1.7 | | |
| PEG-co-NMS | 78 | 58 | 25.64 | 27.8 |
| Syloid-PEG | 20 | 2 | 90 | 98.5 |

PEG of 17,687 g/mol on Syloid silica particles prepared by grafting-to techniques was tested by the procedures outlined in section 4.2.1. The adjusted efficiency data showed that 27.8% of the free polymer was retained in the column, as compared to 98.5% retention of the Syloid-polymer in the diatomaceous earth.

4.2.6

TABLE 6
Syloid-PAM (Grafted-from. Mn: 180,000 g/mol), Free PAM
(Mn: 310,000 g/mol), water (2 ml), Extended wash with water
(2 ml), Filter (Diatomaceous Earth)

| | Amount | Amount After | Retention | Adjusted |
|---|---|---|---|---|
| | Used (mg) | Filtration (mg) | Efficiency (%) | Efficiency (%) |
| Control | — | 1.8 | | |
| PAM | 25 | 8.7 | 65.2 | 72.4 |
| Syloid- | 34 | 7.2 | 78.8 | 88.46 |
| PAM | | | | |

Polyacrylamide of 180,000 g/mol on Syloid silica particles prepared by grafting-from techniques was tested by the procedures outlined in section 4.2.1. The adjusted efficiency data showed that 72.4% of the free polymer of 310,000 g/mol was retained in the column, as compared to 84.1% retention of the Syloid-polymer in the diatomaceous earth.

### Reaction Schemes

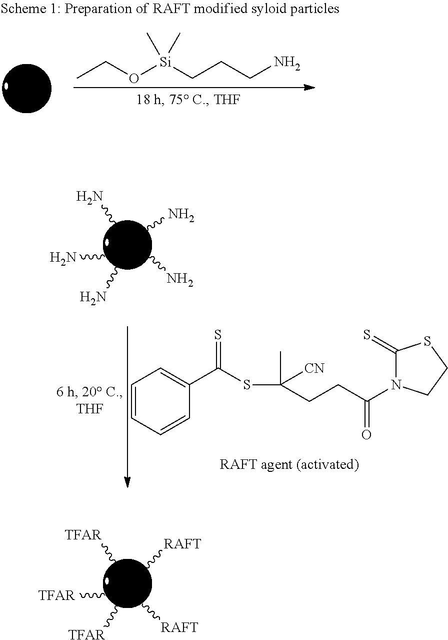

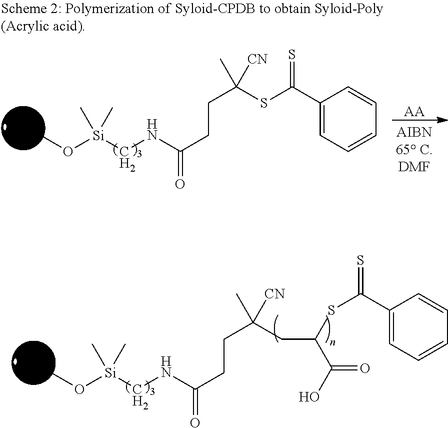

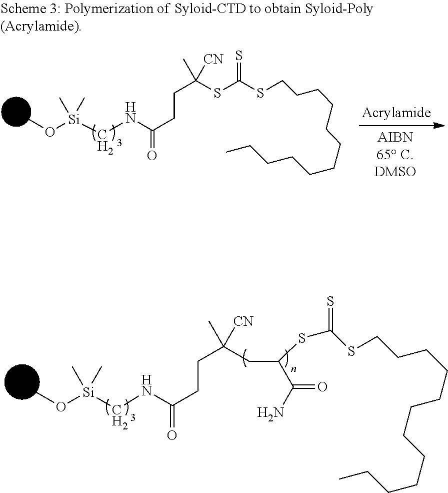

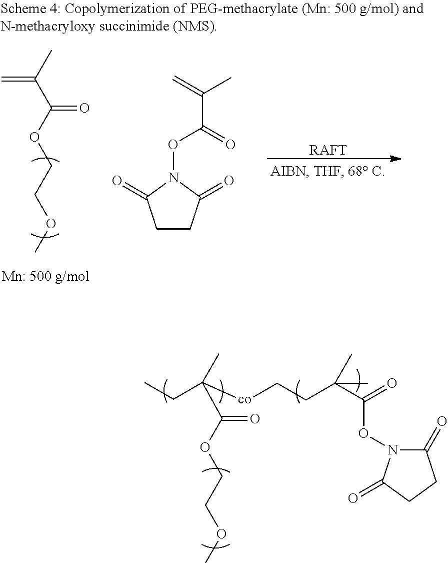

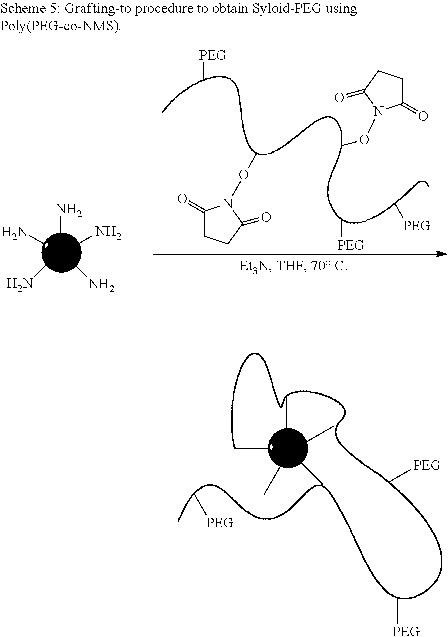

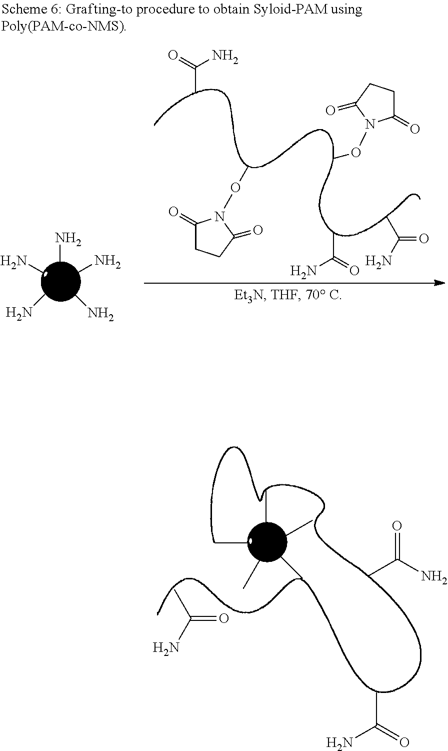

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both, in whole or in part. Furthermore, those of ordinary skill in the art will appreciate that the foregoing description is by way of example only, and is not intended to limit the invention so further described in the appended claims.

While the preferred embodiments of the invention have been illustrated and described, it will be understood that the invention is not so limited. Numerous modifications, alterations, variants, changes, additions and substitutions and equivalents will occur to those with ordinary skill in the art without departing from the spirit and scope of the present invention as described in the claims.

### REFERENCES

(1) Li, C. H., J.; Ryu, C. J.; Benicewicz, B. C. Macromolecules 2006, 31, 3175.

What is claimed is:

1. A chemical additive comprising a solid particulate composition or an aqueous suspension thereof of a polymer or other organic moiety bound covalently to a particulate material for use in hydraulic fracturing fluids for oil and gas-bearing shale.

2. A chemical additive of claim 1 where the particulate material is silica, quartz, ceramics including alumina and titania (TiO₂), clays including kaolinite, illite, chlorite, and/or montmorillonite-smectite, ripidolite, rectorite, bentonite, ferriginous-smectite, vermiculite, saponite, sepiolite, cookeite, beidellite, nontronite, barasym, and corrensite, and metal oxides and sulfides and mixtures thereof.

3. A chemical additive of claim 1 where the particulate material is silica with a particle size of less than 2000 microns.

4. A chemical additive of claim 1 where the polymer or other organic moiety material is formed from unsaturated organic monomers and mixtures thereof.

5. A chemical additive of claim 1 where the polymer or other organic moiety material is formed from vinyl organic monomers and mixtures thereof.

6. A chemical additive of claim 1 where the polymer or other organic moiety material is formed from diene organic monomers or mixtures of diene monomers and vinyl monomers.

7. A chemical additive of claim 1 where the polymer or other organic moiety material is formed from alkyl or aryl substituted acetylenic organic monomers and mixtures thereof.

8. A chemical additive of claim 1 where the polymer or other organic moiety material is formed from ethylene oxide or alkyl and/or aryl substituted ethylene oxides and mixtures thereof.

9. A chemical additive comprising an aqueous suspension of a polymer or other organic moiety covalently bonded to silica with a particle size of less than 2000 microns for use in hydraulic fracturing fluids for gas-bearing shale

10. A chemical additive of claim 9 where the polymer or other organic moiety material covalently bonded is formed by a polymerization using free radical initiation.

11. A chemical additive of claim 9 where the polymer or other organic moiety material covalently bonded is formed by a polymerization using anionic initiation.

12. A chemical additive of claim 9 where the polymer or other organic moiety material covalently bonded is formed by a polymerization using cationic initiation.

13. A chemical additive of claim 9 where the polymer or other organic moiety material covalently bonded is formed by a reversible addition-fragmentation chain transfer polymerization (RAFT) process initiation.

14. A chemical additive of claim 9 where the polymer or other organic moiety material covalently bonded is formed by an atom transfer radical polymerization (ATRP) process initiation.

15. A chemical additive of claim 9 where the polymer or other organic moiety material covalently bonded is formed by a ring opening polymerization process.

16. A chemical additive comprising an aqueous suspension of polyacrylamide and/or poly-N,N-dimethylacrylamide is covalently bonded to silica with a particle size of less than 2000 microns for use in hydraulic fracturing fluids for oil and gas-bearing shale.

17. A chemical additive of claim 16 where the polymer material covalently bonded is polyacrylic acid and/or sodium polyacrylate.

18. A chemical additive of claim 16 where the polymer material covalently bonded is polymethacrylamide and/or poly-N,N-dimethylacrylamide

19. A chemical additive of claim 16 where the polymer material covalently bonded is polymethacrylic acid and/or sodium polymethacylate.

20. A chemical additive of claim 16 where the polymer material covalently bonded is a copolymer or terpolymer.

21. A chemical additive of claim 16 where the polymer material covalently bonded is polyacrylic acid and/or sodium polyacrylate.

22. A chemical additive of claim 16 where the polymer material covalently bonded is polymethacrylamide and/or poly-N,N-dimethylacrylamide.

23. A chemical additive of claim 16 where the polymer material covalently bonded is polymethacrylic acid and/or sodium polymethacylate.

24. A chemical additive of claim 16 where the polymer material covalently bonded is a copolymer of acrylamide and sodium acrylate.

25. A chemical additive of claim 16 where the polymer material covalently bonded is a copolymer of acrylamide and sodium acrylate.

26. A chemical additive of claim 16 where the organic material covalently bonded is a surfactant.

27. A chemical additive of claim 16 where the organic material covalently bonded is a derivative of lauryl sulfate.

28. A chemical additive of claim 16 where the organic material covalently bonded is a polymer of ethylene oxide.

29. A method for lowering the migration of hydraulic fracturing fluid additives of a hydrocarbon-bearing formation penetrated by a well which comprises pumping into the well the chemical additive of claim 1.
